(19) United States
(12) Patent Application Publication
(10) Pub. No.: US 2006/0174789 A1
(43) Pub. Date: Aug. 10, 2006

(54) Stamp device for use in soft lithography and method for producing the same

(76) Inventors: Maik Liebau, Dresden (DE); Eugen Unger, Augsburg (DE)

Correspondence Address: JENKINS, WILSON, TAYLOR & HUNT, P. A., 3100 TOWER BLVD, SUITE 1200, DURHAM, NC, 27707, US

(21) Appl. No.: 11/363,751

(22) Filed: Feb. 28, 2006

Related U.S. Application Data
(63) Continuation of application No. PCT/EP04/10082, filed on Sep. 9, 2004.

(30) Foreign Application Priority Data
Sep. 26, 2003 (DE) 10344777 6

(51) Int. Cl. B41C 3/08

(52) U.S. Cl. 101/401.1

(57) ABSTRACT

A structured, elastic stamp device is disclosed for producing the physical contact of the reactant with the substrate. More specifically, the device comprises a stamp device for carrying out soft-lithographic processes which comprises a base, which is produced from a polymer material, and at least one structured stamp surface of the base, which has a definable surface relief, the stamp surface being structured by means of an impression of a master element which has a defined primary surface relief.

### RELATED APPLICATIONS

This application is a continuation of PCT patent application number PCT/EP2004/010082, filed Sep. 9, 2004, which claims priority to German patent application number 10344777.6 filed Sep. 26, 2003, the disclosures of each of which are incorporated herein by reference in their entirety.

The present invention relates generally to soft-lithographic techniques, which are based on physical contact of a reactant with a substrate.

The present invention relates in particular to a structured, elastic stamp device for producing the physical contact of the reactant with the substrate. More specifically, the invention relates to a stamp device for carrying out soft-lithographic processes which comprises a base, which is produced from a polymer material, and at least one structured stamp surface of the base, which has a definable surface relief, the stamp surface being structured by means of an impression of a master element which has a defined primary surface relief.

For reasons including the deformability of the stamp device, soft-lithographic methods can only be used to a restricted extent with regard to the sizes of structures. One reason for this is that such a stamp is exposed to high mechanical loads. On the one hand, the material used must have a high degree of elasticity, i.e. be “soft”, in order to permit adequately good contact with the substrate, on the other hand, it is required that deformation of the defined surface relief is avoided.

To suppress deformations of conventional stamp devices in a soft-lithographic process, “ideal” aspect ratios must be maintained in the lithography, i.e. aspect ratios in the range from 0.9 to 1.1. In a disadvantageous way, such restrictions on setting the aspect ratio have the effect that conventional soft-lithographic processes using conventional stamp devices cannot be used with sufficient reproduction accuracy for small structures, i.e. structures with a structure width of less than 1 μm (micrometer).

To solve these problems, it has been proposed to use stamp devices made of a polymer material with a high degree of crosslinking and/or incorporated silicate particles. In the publication “H. Schmid, B. Michel, Macromolecules 2000, 33, 3042-3049”, such polymers with a high degree of crosslinking are described as conventional polymers. They allow structures in the range of about 100 nm (nanometers) to be produced.

However, one disadvantage of such use of polymer material with a high degree of crosslinking in soft-lithographic processes according to the prior art is that the greater hardness of the polymer material brought about by the increased degree of crosslinking leads to increased material brittleness. Such brittleness inexpediently allows cracks, structure defects, etc. to occur or the stamp device has cracks and/or fractures.

In a conventional way, as the polymer material from which the base of the stamp device is formed is produced from polydimethyl siloxane (PDMS). Such siloxanes and their use for producing the base for stamp devices are familiar to a person skilled in the art, as described for example in the publication “A. Star, J. F. Stoddart, D. Steuermann, M. Diehl, A. Boukai, E. W. Wong, X. Yang, S.-W. Chung, H. Choi, J. R. Heath, Angew. Chem. Int. Ed. 2001, 40, 1721-1725”.

Consequently, adequate strength of the base, and consequently production of small structures, is not possible.

It is therefore an object of the present invention to provide a stamp device for use in soft lithography which has a base with a greater strength than stamp devices according to the prior art.

This object is achieved according to the invention by a device with the features of patent claim 1.

Furthermore, the object is achieved by a method specified in patent claim 11. Further refinements of the invention emerge from the subclaims.

A central idea of the invention is that a polymer material in which nanoelements are incorporated is used for the base of the stamp device. As a main advantage concerning the above object, nanoelements, such as for example nanotubes or carbon nanotubes, have a high mechanical strength. A further advantage of incorporating nanoelements in the polymer material forming the base of the stamp device is that a higher degree of elasticity of the material of the base can be achieved in comparison with known, more highly crosslinked polymer materials. This leads in an advantageous way to avoidance of fractures, cracks, structure defects, etc., since brittleness of the material can be avoided.

In particular, the present invention has the advantage that, with the stamp device according to the invention, structures can be created in the nanometer range by means of soft-lithographic processes. Since a high degree of elasticity of the stamp device can be provided by the incorporation of, for example, carbon nanotubes (CNT) in the polymer material of the base, a high level of durability of the stamp device is achieved.

Even when the stamp device is used repeatedly in soft-lithographic processes, there are expediently no changes in the interfacial properties of the stamp material.

It is advantageous in this respect that reusability of the stamp device is ensured on account of increased mechanical strength in comparison with conventional stamp devices.

The stamp device according to the invention for use in soft lithography substantially comprises:
a) a base, which is produced from a polymer material; and
b) at least one structured stamp surface of the base, which has a definable surface relief, the stamp surface being structured by means of an impression of a master element which has a defined polymer surface relief, the polymer material of the base containing nanoelements.

Furthermore, the method according to the invention for producing a stamp device for use in soft lithography substantially comprises the following steps:
a) providing a master element which has a defined primary surface relief;
b) coating the primary surface relief with a fluid which contains a polymer material;
c) curing the polymer material, a stamp surface of the stamp device being structured in a way corresponding to the defined primary surface relief of the master element; and
d) peeling the cured polymer material from the master element, in order to obtain a base of the stamp device which has the stamp surface of the stamp device corresponding to the defined primary surface relief of the master element, the polymer material of the base containing nanoelements.

Advantageous developments and improvements of the respective subject matter of the invention can be found in the subclaims.

According to a preferred development of the present invention, the nanoelements are provided as nanotubes and/or as nanowires. The nanotubes are preferably formed on a carbon basis, i.e. in such a way that the nanoelements are provided as carbon nanotubes (CNT).

According to a further preferred development of the present invention, the polymer material from which the base of the stamp device is formed comprises siloxanes.

According to a still further preferred development of the present invention, the polymer material has such an elasticity that it can be peeled from the master element which has a defined primary surface relief, the surface relief of the structured stamp surface of the base being provided as a negative imprint of the defined primary surface relief of the master element.

According to a still further preferred development of the present invention, the polymer material which contains the nanoelements is prepared from polydimethyl siloxane (PDMS).

According to a still further preferred development of the present invention, the nanoelements are formed as silicon, germanium, boron-nitride, gallium-nitride and/or cadmium-sulfide nanowires.

According to a still further preferred development of the present invention, the proportion of the nanoelements contained in the polymer material of the base of the stamp device is between 0.001 and 0.00001% by weight.

According to a still further preferred development of the present invention, the master element is prepared from a silicon material.

According to a still further preferred development of the present invention, the defined primary surface relief of the master element has an aspect ratio in a range between 5 and 0.5.

According to a still further preferred development of the present invention, curing of the polymer material in which a stamp surface of the stamp device is structured in a way corresponding to the defined primary surface relief of the master element is carried out by means of baking of the polymer material. The baking of the polymer material is preferably performed at a temperature of 120° C. for a time period of 12 hours.

According to a still further preferred development of the present invention, the fluid which contains a polymer material for the base of the stamp device is prepared by dispersing the nanoelements in a solvent, in order to obtain a dispersion solution, and by mixing the dispersion solution obtained with a siloxane solution.

According to a still further preferred development of the present invention, the dispersion solution obtained is carried out with the siloxane solution at room temperature.

According to a still further preferred development of the present invention, the solvent in which the nanoelements are dispersed is prepared from dichloromethane.

According to a still further preferred development of the present invention, the fluid is shaken before curing of the polymer material. The fluid is preferably shaken for a time period of 60 minutes at room temperature before the curing of the polymer material.

Exemplary embodiments of the invention are represented in the drawings and described in more detail in the description which follows.

In the drawings:

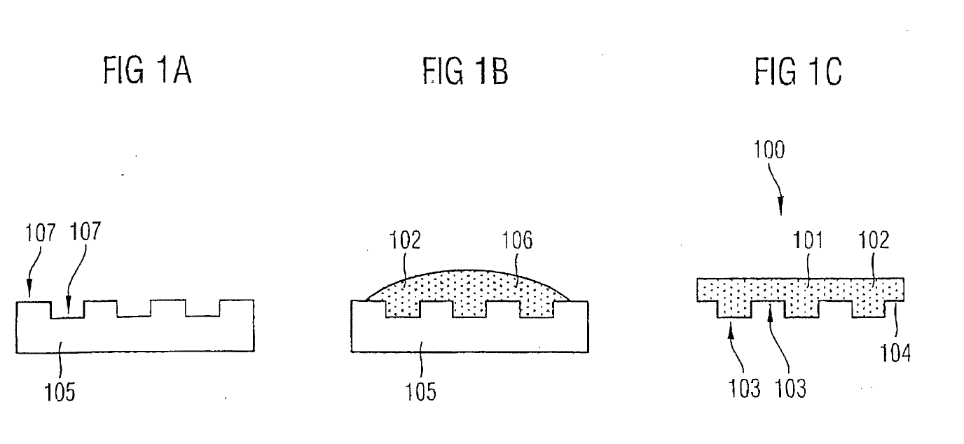

FIG. 1 shows the process steps (a), (b) and (c) for producing a stamp device according to the invention;

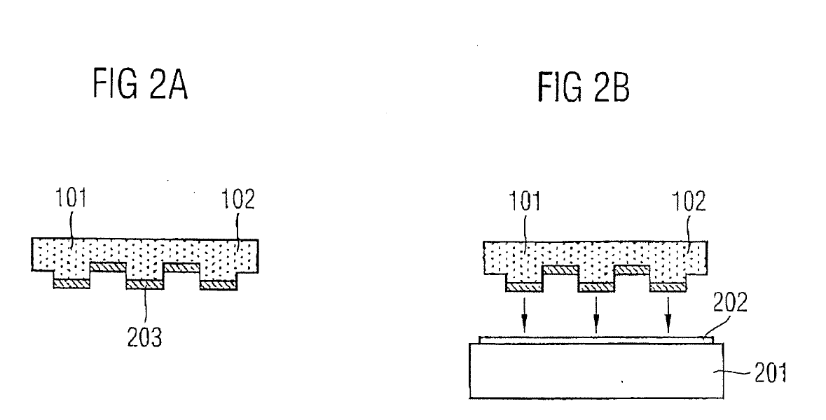

FIG. 2 shows the process steps (d) and (e) by which a soft-lithographic structuring is prepared; and

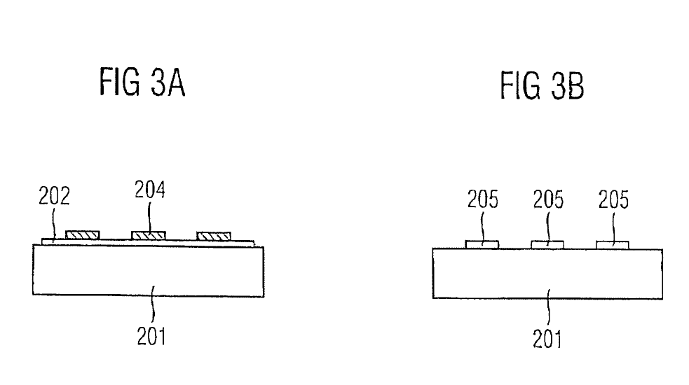

FIG. 3 shows two process steps (f) and (g) for the structuring of a substrate coated with a substrate coating according to a defined surface relief of the stamp surface.

In the figures, the same reference numerals designate components or steps which are the same or functionally the same.

FIG. 1(a) shows a master element 105, which has a defined primary surface relief 107. The primary surface relief 107 of the master element 105 is defined in such a way that a surface relief 103 of a structured stamp surface 104 (described below with reference to FIG. 1(c)) is provided as a negative impression of the defined primary surface relief 107 of the master element 105.

In the process step shown in FIG. 1(b), the primary surface relief 107 of the master element 105 is coated with a fluid, which contains a polymer material 106. According to the invention, nanoelements 102 are incorporated in the fluid, which contains a polymer material 106.

In the exemplary embodiment of the present invention, polydimethyl siloxane (PDMS) is used as a preferred polymer material. The incorporation of the nanoelements in the form of preferably carbon nanotubes allows the mechanical properties of the polymer material to be significantly changed in such a way that a resultant base 101 (see FIG. 1(c)) of the stamp device has a high strength. In this way, structures in the nanometer range can be advantageously created soft-lithographically. After coating the primary surface relief 107 of the master element 105 with the fluid which contains the polymer material 106 and the nanoelements 102, the polymer material 106 is cured, a stamp surface 104 of the stamp device 100 corresponding to the defined primary surface relief 107 of the master element 105 being structured, as illustrated with reference to FIG. 1(c).

FIG. 1(c) shows the defined surface relief 103 of the structured stamp surface 104 of the base 101, which represents a negative impression of the defined primary surface relief 107 of the master element 105. According to the invention, the polymer material 106 contains nanoelements 102 in such a way that the base 101 produced, which together with the stamp surface 104 forms a major component of the stamp device 100, likewise contains nanoelements 102. This leads in an advantageous way to a great strength, since nanoelements, and in particular carbon nanotubes, have a high strength.

Furthermore, it is advantageous that a great elasticity of the polymer material is retained, any occurrence of fractures and/or cracks and/or structure defects being prevented by avoiding brittleness.

FIGS. 2(d) and 2(e) schematically show the use of the stamp device according to the invention in a soft-lithographic method. For this purpose, the surface relief 103 of the base 101, which contains the nanoelements 102, is wetted for example with ink, as shown in FIG. 2(d).

Subsequently, the wetted stamp is pressed onto a substrate 201, which is provided with a substrate coating 202, in the direction indicated by the arrows of FIG. 2(e). The substrate coating 202 preferably consists of a gold material, which transfers a monolayer 204 of the stamp wetting 203 from the stamp device 100 to the substrate coating 202 of the substrate 201.

At the raised locations of the surface relief 103 of the structured stamp surface 104 of the base 101 there is consequently a stamp wetting 203, as shown in FIG. 2(d), such a structure being transferred to the surface of the substrate coating 202 as a monolayer 204, as illustrated in FIG. 3(f).

After etching of the structure shown in FIG. 3(f), for example by a wet etching process, there remain on the substrate 201 the non-etched portions of the substrate coating 202 on the substrate 201, illustrated by a substrate structure 205 in FIG. 3(e).

In an advantageous way, on account of the high strength of the stamp device 100 according to the invention, substrate structures 205 in the nanometer range can be created by means of soft-lithographic processes. Since a high degree of elasticity of the stamp device 100 is retained, the stamp is not destroyed, even in the case of repeated use, nor are interfacial properties of the stamp material changed. Therefore, good reusability of the stamp device is obtained, which leads to a considerable reduction in the cost of soft-lithographic processes.

To produce the base 101, which has the defined surface relief 103, a polymer material 106 is used, preferably prepared as a polydimethyl siloxane (PDMS), such as for example Sylgard 184 produced by Dow Corning.

After curing of the polymer material 106, the cured polymer material 106 is peeled from the master element 105, in order to separate the base 101 of the stamp device 100. The curing of the polymer material is preferably carried out by means of baking. In the preferred exemplary embodiment of the present invention, the baking of the polymer material 106 is carried out at a temperature of 120° C. for a time period of 12 hours.

To produce the fluid, which contains the polymer material 106, nanoelements 102, which are prepared for example from carbon nanotubes (CNT), are dispersed in a solvent in such a way that a dispersion solution is obtained. Subsequently, the dispersion solution obtained is mixed with a siloxane solution.

The mixing of the obtained dispersion solution with the siloxane solution is preferably carried out at room temperature. Furthermore, it is expedient that the fluid is shaken before curing of the polymer material 106, in order to achieve a uniform distribution of the nanoelements 102 in the polymer material. After the curing of the polymer material 106 containing the nanoelements 102, an elastic base 101 of the stamp device 100 that has an adequate mechanical strength is obtained.

It should be pointed out that the proportion of the nanoelements 102 in the polymer material can be varied by variation of the nanoelements 102 in the fluid. In the preferred exemplary embodiment according to the present invention, the proportion of nanoelements is varied between 0.001 and 0.00001% by weight, related to the polymer material 106.

The high mechanical strength of the base 101, combined with adequate elasticity, makes it possible to provide master elements 105 which have an aspect ratio in a range between 5 and 0.5. The surface relief 103 of the structured stamp surface 104 of the base 101 is thereby obtained as an exact negative impression of the defined primary surface relief 107 of the master element 105. Dichloromethane is preferably used as a solvent for dispersing the nanoelements 102, in order to obtain a dispersion solution which is then mixed with the siloxane solution in the further process step, described above.

Although the present invention has been described above on the basis of preferred exemplary embodiments, it is not restricted to these but can be modified in various ways.

The invention is also not restricted to the stated application possibilities.

The substrate may be coated (gold), but also for example consist only of silicon. A natural oxide film would suffice here in order to create a structuring by means of soft-lithographic processes.

### List of Designations

In the figures, the same reference numerals designate components or steps which are the same or functionally the same.
100 stamp device
101 base
102 nanoelement
103 surface relief
104 stamp surface
105 master element
106 polymer material
107 primary surface relief
201 substrate
202 substrate coating
203 stamp wetting
204 monolayer
205 substrate structure

1. A stamp device (100) for use in soft lithography, having:
a) a base (101), which is produced from a polymer material (106); and
b) at least one structured stamp surface (104) of the base (101), which has a definable surface relief (103), the stamp surface (104) being structured by means of an impression of a master element (105) which has a defined primary surface relief (107), characterized in that
c) the polymer material (106) of the base (101) contains nanotubes and/or nanowires (102).

2. The device as claimed in claim 1, characterized in that the nanotubes (102) are formed as carbon nanotubes (CNT).

3. The device as claimed in claim 1, characterized in that the polymer material (106) comprises siloxanes.

4. The device as claimed in claim 1 or 3, characterized in that the polymer material (106) has such an elasticity that it can be peeled from the master element (105), the surface relief (103) of the structured stamp surface (104) of the base (101) being provided as a negative imprint of the defined primary surface relief (107) of the master element (105).

5. The device as claimed in claim 1, 3 or 4, characterized in that the polymer material (106) consists of polydimethyl siloxane (PDMS).

6. The device as claimed in claim 1, characterized in that the nanowires (102) are formed as silicon, germanium, boron-nitride, gallium-nitride and/or cadmium-sulfide nanowires.

7. The device as claimed in claim 1, 3 or 4, characterized in that the polymer material (106) has a proportion of nanotubes and/or nanowires (102) which lies between 0.001 and 0.00001 percent by weight (% by weight).

8. The device as claimed in claim 1, characterized in that the master element (105) is prepared from a silicon material.

9. The device as claimed in claim 1, characterized in that the defined primary surface relief (107) of the master element (105) has an aspect ratio in a range between 5 and 0.5.

10. A method for producing a stamp device (100) for use in soft lithography, with the steps of:
a) providing a master element (105) which has a defined primary surface relief (107);
b) coating the primary surface relief (107) of the master element (105) with a fluid which contains a polymer material (106);
c) curing the polymer material (106), a stamp surface (104) of the stamp device (100) being structured in a way corresponding to the defined primary surface relief (107) of the master element (105); and
d) peeling the cured polymer material (106) from the master element (105), in order to obtain a base (101) of the stamp device (100) which has the stamp surface (104) of the stamp device (100) corresponding to the defined primary surface relief (107) of the master element (105);
characterized in that
e) the polymer material (106) of the base (101) contains nanotubes and/or nanowires (102).

11. The method as claimed in claim 10, characterized in that the curing of the polymer material (106), in which a stamp surface (104) of the stamp device (100) is structured in a way corresponding to the defined primary surface relief (107) of the master element (105), is carried out by means of baking of the polymer material. (106).

12. The method as claimed in claim 11, characterized in that the baking of the polymer material (106) is carried out at a temperature of 120° C. for a time period of twelve hours.

13. The method as claimed in claim 10, characterized in that the fluid is prepared by:
i) dispersing the nanotubes and/or nanowires (102) in a solvent, in order to obtain a dispersion solution; and
ii) mixing the dispersion solution obtained in step i) with a siloxane solution.

14. The method as claimed in claim 13, characterized in that the mixing of the dispersion solution obtained in step i) with the siloxane solution is carried out at room temperature.

15. The method as claimed in claim 13, characterized in that the solvent in which the nanotubes and/or nanowires (102) are dispersed is prepared from dichloromethane.

16. The method as claimed in claim 10, characterized in that the fluid is shaken before step c) of curing the polymer material (106).

17. The method as claimed in claim 16, characterized in that the fluid is shaken for a time period of 60 minutes at room temperature before the curing of the polymer material (106).
